(19) United States
(12) Patent Application Publication
(10) Pub. No.: US 2021/0107358 A1
(43) Pub. Date: Apr. 15, 2021

(54) VEHICLE

(71) Applicant: TOYOTA JIDOSHA KABUSHIKI KAISHA, Aichi-ken (JP)

(72) Inventors: Hidekazu SHIBATA, Toyota-shi (JP); Atsushi NARITA, Okazaki-shi (JP); Masaki MOTOZAKI, Toyota-shi (JP)

(21) Appl. No.: 17/020,819

(22) Filed: Sep. 15, 2020

(30) Foreign Application Priority Data
Oct. 11, 2019 (JP) 2019-188195

(51) Int. Cl. B60K 35/00; B62D 1/04; B60R 16/00; B62D 1/16

(52) U.S. Cl. CPC B60K 35/00; B62D 1/04; B60R 16/005; B62D 1/16; B60K 2370/182; B60K 2370/155; B60K 2370/178; B60K 2370/171; B60K 2370/152

(57) ABSTRACT

A vehicle includes: a steering wheel arranged at a vehicle front side of a driver's seat; a center display unit provided at a vehicle front side of the steering wheel, and configured to display information toward the driver's seat; a side display unit provided at one or both sides, in a vehicle width direction, of the center display unit, being inclined in a direction toward a vehicle rear side progressively away from the center display unit in plan view, and configured to display information toward the driver's seat; and an operation unit provided at the side display unit and configured to operate a vehicle onboard device.

### CROSS-REFERENCE TO RELATED APPLICATION

This application claims priority under 35 USC 119 from Japanese Patent Application No. 2019-188195, filed on Oct. 11, 2019, the disclosure of which is incorporated by reference herein.

### BACKGROUND

### Technical Field

The present disclosure relates to a vehicle.

### Related Art

Japanese Patent Application Laid-Open No. 2016-196228 discloses a display system for switching a video display between a head-up display and a center display.

In a structure including a plurality of display units, such as the display system disclosed in Japanese Patent Application Laid-Open No. 2016-196228, the size of the display unit is increased and directed toward the driver's seat in order to transmit more information to the occupant. On the other hand, when the instrument panel is provided with operation buttons for in-vehicle devices, it becomes difficult for the occupant to operate the operation buttons when the display unit is large.

### SUMMARY

The present disclosure provides a vehicle that may obtain a large amount of information from a display unit without impairing the operability of onboard devices.

A first aspect of the present disclosure is a vehicle including: a steering wheel arranged at a vehicle front side of a driver's seat; a center display unit provided at a vehicle front side of the steering wheel, and configured to display information toward the driver's seat; a side display unit provided at one or both sides, in a vehicle width direction, of the center display unit, being inclined in a direction toward a vehicle rear side progressively away from the center display unit in plan view, and configured to display information toward the driver's seat; and an operation unit provided at the side display unit and configured to operate a vehicle onboard device.

In the vehicle according to the first aspect of the present disclosure, a steering wheel is provided at a vehicle front side of a driver's seat. In addition, a center display unit is provided at a vehicle front side of the steering wheel, and this center display unit is configured to display information toward the driver's seat. Further, a side display unit is provided at one or both sides, in a vehicle width direction, of the center display unit. Here, the side display unit is inclined in a direction away from the center display unit progressively toward a vehicle rear side in plan view, and is configured to display information toward the driver's seat. Thereby, an occupant sitting in the driver's seat can visually recognize information displayed at the center display unit and the side display unit.

Further, an operation unit is provided at the side display unit, and the configuration is such that onboard devices can be operated by the operation unit. In this way, by providing the operation unit at the side display unit, the side display unit does not interfere when operating onboard devices.

In a second aspect of the present disclosure, in the first aspect, the operation unit may include at least a start switch for starting the vehicle.

In the vehicle according to the second aspect of the present disclosure, by providing the start switch at the side display unit, it is not necessary to provide the start switch on the instrument panel. Thereby, even if the instrument panel is covered with the side display unit, the vehicle may be easily started.

In a third aspect of the present disclosure, in the first aspect or the second aspect, the center display unit and the side display unit are disposed continuously in the vehicle width direction.

In the vehicle according to the third aspect of the present disclosure, since the center display unit and the side display unit can be shown integrally, compared with a configuration in which the center display unit and the side display unit are spaced apart from each other, the design is improved.

In a fourth aspect of the present disclosure, in any one of the first to third aspects, the center display unit may be configured to change a depth of display in accordance with a type of information to be displayed.

In the vehicle according to the fourth aspect of the present disclosure, the depth of display can be changed according to the type of information, so that the occupant can intuitively grasp the type of information. For example, by displaying information regarding the vehicle at the front and displaying information regarding the exterior of the vehicle at the back, the type of information can be grasped without the occupant being conscious thereof.

In a fifth aspect of the present disclosure, in any one of the first aspect to the fourth aspect, the steering wheel may be attached to an instrument panel via a steering column, and a column cover covering the steering column has a dimension in the vehicle width direction that decreases progressively toward the vehicle front side in plan view.

In the vehicle according to the fifth aspect of the present disclosure, the length of the column cover in the vehicle width direction gradually decreases progressively toward the front side of the vehicle. For this reason, the occupant turns their line of sight toward the front of the vehicle along the outer shape of the column cover, whereby the line of sight can be naturally guided to the center display unit.

In a sixth aspect of the present disclosure, in any one of the first aspect to the fourth aspect, the steering wheel may be formed in a U-shape that is open upward as viewed from a side of the driver's seat in an initial position before steering.

In the vehicle according to the sixth aspect of the present disclosure, since there is no portion to be gripped at a top part of the steering wheel, the steering wheel is not an obstacle when the occupant is viewing the center display unit.

According to the vehicle of the present disclosure, a large amount of information may be obtained from a display unit without impairing the operability of onboard devices.

### BRIEF DESCRIPTION OF THE DRAWINGS

An exemplary embodiment will be described in detail based on the following figures, wherein:

FIG. 1 is a perspective view of a front part of a vehicle compartment of a vehicle according to an embodiment, as viewed from a vehicle rear side and a vehicle upper side;

FIG. 2 is a plan view of the driver's seat of the vehicle according to the embodiment as viewed from above the vehicle; and

FIG. 3 is a main part enlarged view schematically showing, in an enlarged manner, a view of a front part of a vehicle cabin viewed from a driver seat in the vehicle according to the embodiment.

### DETAILED DESCRIPTION

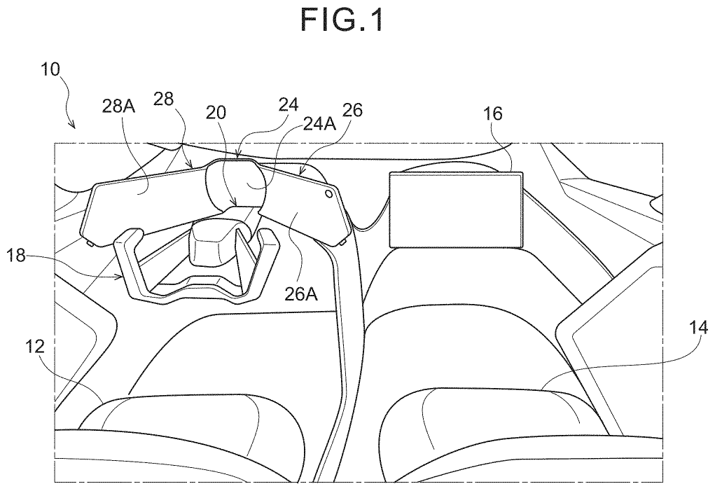

A vehicle 10 according to an embodiment will be described with reference to the drawings. As shown in FIG. 1, a driver's seat 12 and a passenger seat 14 are provided in the cabin of the vehicle 10. The vehicle 10 of the present embodiment is, for example, a left-hand drive vehicle, and a driver's seat 12 is provided on the left side of the vehicle.

The passenger seat 14 is provided on the right side of the vehicle relative to the driver seat 12, and a passenger seat side display 16 is disposed at a vehicle front side of the passenger seat 14. The passenger seat side display 16 is formed in a substantially rectangular shape, and the display surface faces the passenger seat 14. On the passenger seat side display 16, for example, contents related to entertainment such as movies and television are displayed.

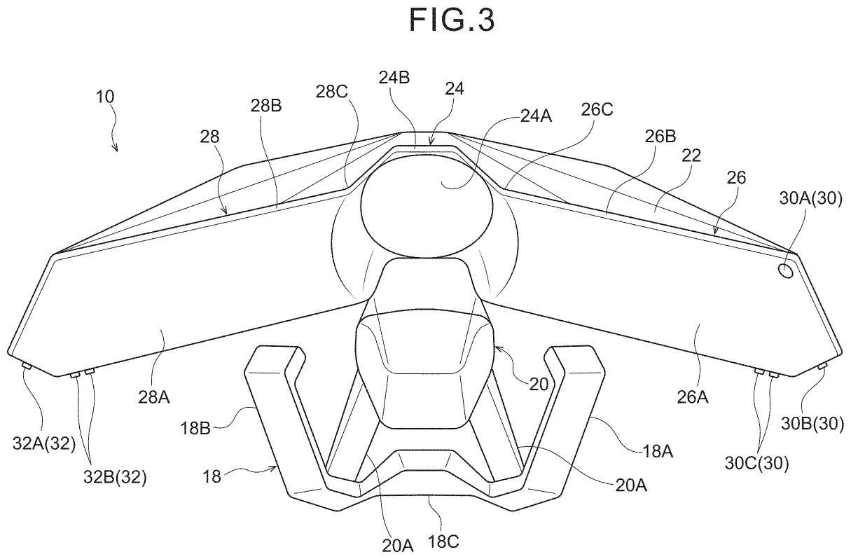

Further, a steering wheel 18 is provided at a vehicle front side of the driver's seat 12 in the vehicle. As shown in FIG. 3, the steering wheel 18 is a modified steering wheel formed in a U-shape that is open upward when viewed from the driver's seat 12 at an initial position before steering.

Specifically, the steering wheel 18 is configured to include a right grip 18A, a left grip 18B, and a lower coupling 18C. The right grip 18A forms the right side of the steering wheel 18, is formed in a long plate shape, and extends in the vehicle up-down direction. The upper end of the right grip 18A is bent toward the vehicle front side. A switch (not shown) that can be operated is provided on the right grip 18A.

The left grip 18B forms the left side of the steering wheel 18, is formed in a long plate shape, and extends in the vehicle up-down direction. The upper end of the left grip 18B is bent toward the vehicle front side. A switch (not shown) that can be operated is provided on the left grip 18B. Further, the lower end of the right grip 18A and the lower end of the left grip 18B are connected in the vehicle width direction by a lower connecting portion 18C.

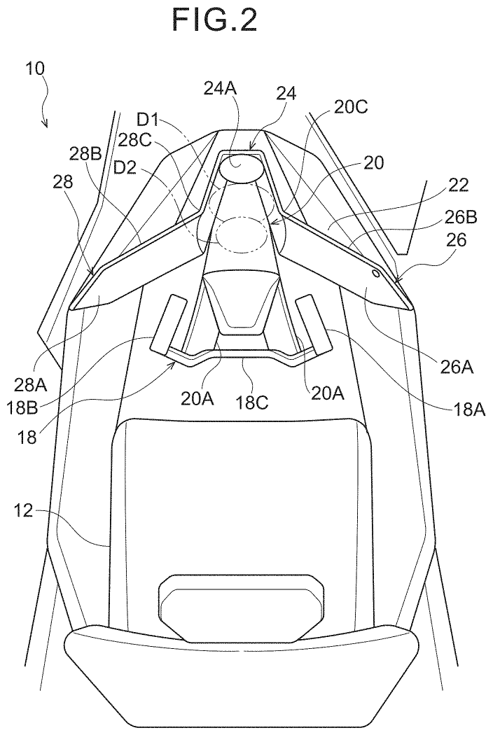

As shown in FIG. 2, the steering wheel 18 is attached to the instrument panel 22 via a steering column (not shown). The steering column is covered by the column cover 20. The length of the column cover 20 in the vehicle width direction gradually decreases toward the vehicle front side in plan view. That is, the column cover 20 is formed in a substantially triangular shape having its vertex at the front side of the vehicle in plan view.

The rear end of the column cover 20 is branched into two parts, i.e., two branch portions 20A which are connected to the steering wheel 18. Specifically, one branch 20A is connected to the lower end of the right grip 18A, and the other branch 20A is connected to the lower end of the left grip 18B.

Here, a center display unit 24 is provided on the vehicle front side of the steering wheel 18, and the center display unit 24 is disposed in front of the driver's seat 12. As shown in FIG. 3, the center display unit 24 includes a substantially circular center display surface 24A, and the center display surface 24A faces the driver's seat 12.

The center display unit 24 is configured so that plural types of information can be displayed by changing the depth. As shown in FIG. 2, in the present embodiment, as an example, the configuration is such that three types of information are displayed: information displayed on the surface of the center display surface 24A, information displayed on first virtual surface D1 displayed further toward the side of the driver's seat 12 side than the center display surface 24A, and information displayed on second virtual surface D2 displayed further toward the side of the driver's seat 12 than the first virtual surface D1.

Information regarding the exterior of vehicle 10 is displayed on the surface of the innermost center display surface 24A. For example, on the surface of the center display surface 24A, information on obstacles ahead of the vehicle 10, icons indicating the traveling direction of the vehicle 10, and the like are displayed. In addition, information on the vehicle 10 is displayed on the first virtual surface D1. For example, on the first virtual surface D1, information such as a vehicle speed, a remaining fuel amount, and a remaining battery amount is displayed.

Further, information for alerting the occupant is displayed on the second virtual surface D2 at the forefront. Thus, the center display unit 24 is configured to change the depth to be displayed according to the type of information to be displayed. Note that various methods can be adopted as a method of displaying information by changing the depth. For example, information may be displayed using a method such as a lenticular method or a parallax barrier method. Alternatively, a method of disposing a transparent screen at each of the first virtual surface D1 and the second virtual surface D2 and projecting an image onto these screens may be adopted.

On the vehicle right side of the center display section 24, a right side display section 26 is provided as a side display section. On the vehicle left side of the center display unit 24, a left side display unit 28 is provided as a side display unit. The center display unit 24 is sandwiched between the right side display unit 26 and the left side display unit 28 from the left and right. The right side display unit 26 and the left side display unit 28 are each inclined in a direction toward the rear side of the vehicle progressively away from the center display unit 24 in plan view. In other words, the right side display section 26 and the left side display section 28 are inclined in directions away from each other progressively toward the vehicle rear side in plan view.

Specifically, as shown in FIGS. 2 and 3, the front part of the right side display part 26 extends from the right end of the center display part 24 to the vehicle rear side and the vehicle right side along the column cover 20. Further, a side further to the rear of a bent portion 26C in the right side display portion 26 is inclined to the vehicle rear side and the vehicle right side so as to depart from the column cover 20, and the rear end of the right side display portion 26 has a tip with a pointed shape. A right side display surface 26A for displaying information toward the driver's seat 12 is provided at a rear portion of the right side display unit 26.

On the other hand, the front part of the left side display part 28 extends from the left end of the center display part 24 to the vehicle rear side and the vehicle left side along the column cover 20. Further, a side further to the rear of a bent portion 28C in the left side display portion 28 is inclined to the vehicle rear side and the vehicle left side so as to depart from the column cover 20, and the rear end of the left side display portion 28 has a tip with a pointed shape. A left side display surface 28A for displaying information toward the driver's seat 12 is provided at a rear portion of the left side display unit 28.

Here, in the present embodiment, the center display unit 24, the right side display unit 26, and the left side display unit 28 are arranged continuously in the vehicle width direction. That is, the upper edge 24B of the center display section 24, the upper edge 26B of the right side display section 26, and the upper edge 28B of the left side display section 28 are continuous.

As shown in FIG. 3, the right side display unit 26 is provided with a right side operation unit 30 as an operation unit. The right side operation unit 30 includes a right side first switch 30A, a right side second switch 30B, and two right side third switches 30C. The right side first switch 30A is disposed at an upper left end of the right side display surface 26A, and is a start switch for starting the vehicle 10. For this reason, by depressing the right side first switch 30A, the starter, which is an in-vehicle device, is operated. In the case of an electric vehicle, by operating the right side first switch 30A, the EV system, which is an in-vehicle device, is started. For example, when the vehicle 10 is started by operating the right side first switch 30A, an effect such that an image of light or the like flows respectively from the right side display surface 26A and the left side display surface 28A toward the center display surface 24A, may be performed. Such an effect may notify the occupant that the vehicle 10 has been started.

The right side second switch 30B protrudes from the end surface of the right side display unit 26. In the present embodiment, as an example, the right side second switch 30B is a switch for operating and stopping the air conditioner, which is a vehicle-mounted device. The two right side third switches 30C protrude from the lower surface of the right side display unit 26, and are switches for changing the set temperature of the air conditioner, as an example in the present embodiment. That is, one right side third switch 30C is a switch for increasing the set temperature, and the other right side third switch 30C is a switch for decreasing the set temperature.

The left side display section 28 is provided with a left operation section 32 as an operation section. The left operation section 32 is provided with a left first switch 32A and two left second switches 32B. The left first switch 32A protrudes from the end surface of the left side display unit 28, and in the present embodiment, as an example, is a switch for operating a display device that performs display on the right side display unit 26 and the left side display unit 28. That is, the configuration is such that by pressing the left first switch 32A, information displayed on the right side display unit 26 and the left side display unit 28 can be changed.

The two left second switches 32B protrude from the lower surface of the left side display unit 28, and are, as an example, volume switches for adjusting volume in the present embodiment. That is, one left second switch 32B is a switch for increasing the set volume, and the other left second switch 32B is a switch for decreasing the set volume.

### Operation

Operation of the present embodiment is described next.

In the vehicle 10 according to the present embodiment, the right side display unit 26 and the left side display unit 28 are each inclined in a direction away from each other progressively toward the vehicle rear side in a plan view, and display information toward the driver's seat 12. Thereby, the occupant sifting in the driver's seat 12 can visually recognize the information displayed on the center display unit 24, the right side display unit 26, and the left side display unit 28.

The right side display unit 26 is provided with a right operation unit 30, and the left side display unit 28 is provided with a left operation unit 32. The right-side operation unit 30 and the left-side operation unit 32 are configured so that in-vehicle devices can be operated. As described above, by providing the operation units on the side display units, the right operation unit 30 does not interfere with the right side display unit 26 when operating the vehicle-mounted devices. That is, much information can be obtained from the center display unit 24, the right side display unit 26, and the left side display unit 28 without impairing the operability of the on-vehicle devices.

In particular, in the present embodiment, since the right side display unit 26 is provided with the right first switch 30A as a start switch, it is not necessary to provide a start switch on the instrument panel 22. Thereby, even if the instrument panel 22 is covered with the right side display part 26 and the left side display part 28, the vehicle 10 can be easily started.

In the present embodiment, since the center display unit 24, the right side display unit 26, and the left side display unit 28 are arranged continuously, the center display unit 24, the right side display unit 26, and the left side display unit 28 can be shown in an integrated fashion. As a result, the design is improved as compared with a configuration in which the center display unit 24 is disposed apart from the right side display unit 26 and the left side display unit 28.

Further, in the present embodiment, the information about the vehicle 10 is displayed on the first virtual surface D1 on the front side, and the information about the outside of the vehicle 10 is displayed on the surface of the center display surface 24A on the back side, so that the occupant can grasp the type of information without being conscious thereof.

Furthermore, in the present embodiment, the shape of the column cover 20 is formed such that its length in the vehicle width direction gradually decreases progressively toward the vehicle front side in plan view. Thus, the line of sight of the occupant can be guided to the center display unit 24. Further, when it is desired that the occupant's line of sight is to be directed to the center display section 24, an effect of an image such as light flowing from each of the right side display surface 26A and the left side display surface 28A toward the center display surface 24A is performed, whereby the line of sight of the occupant can be reliably directed to the center display unit 24.

Further, the steering wheel 18 of the present embodiment is formed in a U-shape whose upper part is open when viewed from the driver's seat 12 side at an initial position before steering. Thus, the center display portion 24 can be visually recognized from above the steering wheel 18, and the steering wheel 18 does not become an obstacle.

Although an exemplary embodiment has been described above, the present disclosure can, of course, be implemented in various forms within a scope that does not depart from the gist thereof. For example, in the above-described embodiment, the right first switch 30A, the right second switch 30B, and the two right third switches 30C that constitute the right operation unit 30, and the left first switch 32A, and the two left second switches 32B that constitute the left operation unit 32, are configured as switches to be depressed, but the disclosure is not limited to this. That is, a dial-type operation unit and a slide-type operation unit may be used.

Further, in the above-described embodiment, the center display unit 24 is configured to change the depth of display according to the type of information to be displayed; however, the present disclosure is not limited to this. That is, in FIG. 2, the configuration may be such that the image is not displayed on the first virtual surface D1 and the second virtual surface D2.

Further, in the above embodiment, the center display unit 24, the right side display unit 26, and the left side display unit 28 are arranged continuously, but the disclosure is not limited to this. For example, a gap may be formed between the center display unit 24 and the right side display unit 26 to such an extent that they can be seen integrally as a whole.

Furthermore, in the above-described embodiment, the steering wheel 18 is formed in a U-shape whose upper part is open when viewed from the driver's seat 12 at an initial position before steering, but it is not limited thereto, and may be shaped otherwise. For example, the outer shape of the steering wheel may be circular. Further, the outer diameter of the steering wheel may be formed in a substantially rectangular shape whose longitudinal direction is the vehicle width direction.

In the above embodiment, the right side display unit 26 is provided on the vehicle right side of the center display unit 24, and the left side display unit 28 is provided on the vehicle left side of the center display unit 24. However, the present disclosure is not limited to this. For example, a configuration including only the right side display unit 26 may be employed. Conversely, a configuration including only the left side display unit 28 may be employed.

What is claimed is:

1. A vehicle, comprising:
a steering wheel arranged at a vehicle front side of a driver's seat;
a center display unit provided at a vehicle front side of the steering wheel, and configured to display information toward the driver's seat;
a side display unit provided at one or both sides, in a vehicle width direction, of the center display unit, being inclined in a direction toward a vehicle rear side progressively away from the center display unit in plan view, and configured to display information toward the driver's seat; and
an operation unit provided at the side display unit and configured to operate a vehicle onboard device.

2. The vehicle of claim 1, wherein the operation unit includes at least a start switch for starting the vehicle.

3. The vehicle of claim 1, wherein the center display unit and the side display unit are disposed continuously in the vehicle width direction.

4. The vehicle of claim 1, wherein the center display unit is configured to change a depth of display in accordance with a type of information to be displayed.

5. The vehicle of claim 1, wherein:
the steering wheel is attached to an instrument panel via a steering column, and
a column cover covering the steering column has a dimension in the vehicle width direction that decreases progressively toward the vehicle front side in plan view.

6. The vehicle of claim 1, wherein the steering wheel is formed in a U-shape that is open upward as viewed from a side of the driver's seat in an initial position before steering.

7. The vehicle of claim 4, wherein three types of information are displayed at the center display unit, the three types of information comprising:
information that is displayed on a surface of a circular center display surface;
information that is displayed on a first virtual surface disposed further toward the side of the driver's seat than the center display surface; and
information that is displayed on a second virtual surface disposed further toward the side of the driver's seat than the first virtual surface.

8. The vehicle of claim 7, wherein:
information related to an exterior of the vehicle is displayed at the center display surface,
information related to the vehicle is displayed at the first virtual surface, and
information related to an alert to the occupant is displayed at the second virtual surface.
